(19) United States
(12) Patent Application Publication
(10) Pub. No.: US 2024/0312108 A1
(43) Pub. Date: Sep. 19, 2024

(54) Shader Optimizations for Rendering Semi-Transparent Materials

(71) Applicant: Apple Inc., Cupertino, CA (US)

(72) Inventors: Daniel S. Shervheim, San Jose, CA (US); Kyle Fisher, Sunnyvale, CA (US); Michael A. Dunkley, Sunnyvale, CA (US)

(21) Appl. No.: 18/606,585

(22) Filed: Mar. 15, 2024

Related U.S. Application Data
(60) Provisional application No. 63/490,582, filed on Mar. 16, 2023.

(51) Int. Cl. G06T 15/00; G06T 15/06; G06T 15/08; G06T 15/10

(52) U.S. Cl. CPC G06T 15/005; G06T 15/06; G06T 15/08; G06T 15/10; G06T 2210/21; G06T 2210/62

(57) ABSTRACT

Techniques are disclosed for a three-dimensional (3D) graphical rendering system, comprising: obtaining a first 3D graphical object, wherein the first 3D graphical object is associated with at least a first semi-transparent material, wherein the first material is associated with an adjustable density value and comprises at least a first plane (or 3D volume) with an adjustable position within a virtual environment; determining a transparency value based, at least in part, on the adjustable density value and a distance between the first plane and the first 3D graphical object (or a density of the 3D volume); and rendering, from a first viewpoint and using a first shader, at least a portion of the first 3D graphical object by applying the determined transparency value to the first material. Rendering the first 3D graphical object may further comprise blending between the first material and a second material according to the determined transparency value.

### BACKGROUND

This disclosure relates generally to computer graphics. More particularly, but not by way of limitation, this disclosure relates to techniques and systems for using optimized shaders for the rendering of semi-transparent materials, especially in systems, e.g., resource-constrained systems, that do not use multi-pass rendering operations (wherein “multi-pass rendering,” in this context, refers to rendering graphics by using at least a first rendering pass for opaque objects and then a second rendering pass for semi-transparent objects).

The advent of mobile, multifunction electronic devices, such as smartphones, wearables, and tablet devices, has resulted in a desire for small form factor devices capable of generating high levels of image quality in real time or near-real time—and often with constrained thermal, memory, and/or processing budgets. Some such electronic devices are capable of generating and presenting so-called “extended reality” (XR) environments on display screens, such as head mounted devices (HMD), or the like. An XR environment may include a wholly- or partially-simulated environment, including one or more virtual objects, which users of such electronic device can sense and/or interact with. In XR, a subset of a person's physical motions, or representations thereof, may be tracked, and, in response, one or more characteristics of the one or more virtual objects simulated in the XR environment may be adjusted in a manner that comports with at least one law of physics.

When graphical content is displayed in XR environments, novel and highly-efficient graphics rendering techniques, such as those described herein, may be employed that utilize optimized shaders to render semi-transparent materials (i.e., materials that are at least partially transparent, e.g., water, fog, clouds, or the like) in the same rendering pass as opaque objects in the rendered scene.

### BRIEF DESCRIPTION OF THE DRAWINGS

FIG. 1A shows an output of an opaque rendering pass of an exemplary scene.

FIG. 1B shows an output of an opaque rendering pass of an exemplary scene that includes a planar water material.

FIG. 1C shows an output of a single-pass rendering operation that applies an optimized transparency-aware shader to the terrain, but not to the other three-dimensional (3D) objects in the exemplary scene.

FIG. 1D shows an output of a single-pass rendering operation that applies an optimized transparency-aware shader to the terrain, as well as the other 3D objects in the exemplary scene, to emulate a multi-pass rendering operation, according to one or more embodiments.

FIG. 2A shows an example of a rendering operation that computes where an exemplary ray emanating from a camera viewpoint intersects with a semi-transparent, planar water material, according to one or more embodiments.

FIG. 2B shows an example of a rendering operation that computes where an exemplary ray emanating from a camera viewpoint intersects with a 3D object that is unaware of a semi-transparent, planar water material.

FIG. 2C shows an example of a rendering operation that computes where an exemplary ray emanating from a camera viewpoint intersects with a semi-transparent, planar fog/cloud material, according to one or more embodiments.

FIG. 2D shows an example of a rendering operation that computes where an exemplary ray emanating from a camera viewpoint intersects at multiple points with a semi-transparent, 3D volumetric fog/cloud material, according to one or more embodiments.

FIGS. 3A-3B show flowcharts for a technique for rendering opaque and semi-transparent 3D objects in a single rendering pass using a planar, semi-transparent material, according to one or more embodiments.

FIGS. 3C-3D show flowcharts for a technique for rendering opaque and semi-transparent 3D objects in a single rendering pass using a semi-transparent 3D volumetric material, according to one or more embodiments.

FIG. 4 shows, in block diagram form, a simplified system diagram according to one or more embodiments.

FIGS. 5A-5B show exemplary systems for use in various computer-simulated XR technologies.

### DETAILED DESCRIPTION

This disclosure pertains to systems, methods, and computer readable media for implementing novel techniques to perform improved 3D graphical rendering of semi-transparent materials, especially in resource-constrained systems, such as those that may be used in extended reality (XR) platforms. The techniques disclosed herein may be specially designed to render all of the geometry of a 3D graphical object that is positioned below (or behind) a defined planar surface (or 3D volume) representative of a first, semi-transparent material (e.g., water, fog, clouds, or the like) with a special optimized shader. The optimized shader may run in a single, “opaque” rendering pass, so as to avoid all of the costs in traditional rendering associated with performing a second, “transparency” rendering pass that takes as input the opaque color and depth textures of all objects in the virtual environment already rendered in a first opaque rendering pass.

Further, in some embodiments, the optimized shader may take as input a position within the virtual environment of the defined planar surface or 3D volume representative of the first, semi-transparent material (e.g., a height value and/or rotation angle describing a 2D material plane within the virtual environment, e.g., a water material, or a set of coordinates and dimensions describing a 3D volume, e.g., comprising a fog or cloud-like material) and calculate where a ray emanating from a camera viewpoint towards the 3D graphical object intersects with the planar surface (or 3D volume) representative of the first, semi-transparent material.

At the time of rendering, the optimized shader will have access to the intersection point(s) of the ray with both the 3D graphical object and the planar surface (or 3D volume) that is made of the first, semi-transparent material, which it can then use to shade the surface of the 3D object, e.g., by blending a second material associated with the 3D object with the appropriate amount of the first, semi-transparent material (e.g., based on an adjustable density value associated with the first, semi-transparent material). In this way, the techniques disclosed herein emulate the visual blending effects traditionally associated with multi-pass transparent rendering while doing so in a single pass render operation—and with none of the additional associated costs of the multiple passes needed in traditional multi-pass transparent rendering.

As mentioned above, the techniques described herein may provide specific enhancements for rendering and presenting graphical information in XR environments. Some XR environments may be filled (or almost filled) with virtual objects or other simulated content (e.g., in the case of pure virtual reality (VR) environments). However, in other XR environments (e.g., in the case of augmented reality (AR) environments, and especially those wherein the user has a wide field of view (FOV), such as a horizontal FOV of 70 degrees or greater), there may be large portions of the user's FOV that have no virtual objects or other simulated content in them at certain times. In some cases, the non-rendered portions of a user's FOV may be filled with imagery captured by so-called “pass-through” cameras of the real-world environment around the user. As used herein, the term “pass-through” or “pass-through video,” denotes video images (e.g., a video stream) of a user's physical environment that may be shown on an opaque display of an XR-capable device. As mentioned above, pass-through video images may be captured by one or more camera(s) that are communicatively coupled to the XR-capable device.

In other cases, some virtual objects (and/or other simulated content) in an XR environment may be occluded by certain other (virtual or real) foreground objects in the XR environment. In still other XR environments, it may simply be desirable to perform different graphical processing operations on particular parts of the scene (e.g., applying an optimized shader, such as those described herein, to semi-transparent materials that may be present in a “system-level” layer of the XR environment, but applying traditional, multi-pass rendering operations to render any semi-transparent materials present in one or more “application-level” layers being rendered on top of the aforementioned system-level layer).

Thus, what is needed are improved techniques for rendering 3D graphical content in an XR environment (or other resource-constrained environment) that provide improved performance and efficiency for single-pass rendering operations that include semi-transparent materials. For example, such improvements may be realized by mathematically estimating an effective transparency of a “virtual” semi-transparent material when rendering 3D objects located within a virtual environment and “behind” the virtual semi-transparent material with respect to a current camera viewpoint. (The term “virtual” is used here in quotation marks because, in some implementations, there is no actual 3D mesh representative of the semi-transparent material actually present in the virtual environment—the properties of such semi-transparent materials are simply being simulated and then used to influence the final rendered color values for the opaque objects in the virtual environment.)

In one or more embodiments, a method for graphical rendering is described, comprising: obtaining a first 3D graphical object, wherein the first 3D graphical object is associated with at least a first material, and wherein the first material is associated with an adjustable density value and comprises at least a first plane with an adjustable position within a virtual environment; determining a transparency value based, at least in part, on the adjustable density value and a distance between the first plane and the first 3D graphical object; and rendering, from a first viewpoint and using a first shader (e.g., an optimized, semi-transparent material-aware shader), at least a portion of the first 3D graphical object in the virtual environment by applying the determined transparency value to the first material. In some such embodiments, the rendering of the first 3D graphical object in the virtual environment may preferably comprise a single pass rendering operation that renders both opaque and non-opaque (i.e., semi-transparent) materials in the virtual environment.

In some embodiments, the first 3D graphical object is further associated with a second material, and the rendering of at least a portion of the first 3D graphical object in the virtual environment further comprises: blending between the first material and the second material according to the determined transparency value (e.g., a simple linear or alpha blending operation may be performed, or more complex blending operations may also be performed, as desired for a given implementation).

In some such embodiments, the rendering of at least a portion of the first 3D graphical object in the virtual environment further comprises, for one or more rendered pixels of the first 3D graphical object: (a) computing, for a first ray emanating from the first viewpoint and terminating at a respective rendered pixel of the first 3D graphical object, a first intersection point between the first ray and the first plane; (b) computing a second intersection point between the first ray and the first 3D graphical object, wherein the second intersection point is behind the first plane with respect to the first viewpoint; (c) determining a first distance between the first intersection point and the second intersection point; (d) determining based, at least in part, on the first distance and the adjustable density value of the first material, a first transparency value to apply to the first material at the second intersection point; and (c) rendering a portion of the first 3D graphical object at the second intersection point based, at least in part, on the determined first transparency value, the first material, and a portion of the second material corresponding to the first 3D graphical object at the second intersection point.

In some embodiments, the first plane may comprise a horizontal plane, and the adjustable position may comprise an adjustable height (e.g., z-axial) value or coordinate (e.g., x-y-z-axial coordinate values) within the virtual environment. In other embodiments, the first plane further comprises a rotatable and/or scalable plane within the virtual environment. In some other embodiments, the first material comprises a semi-transparent material (e.g., fog, mist, water, cloud, dust, or particles) with a predetermined and/or adjustable “baseline” density value.

In some embodiments, determining the transparency value further comprises applying the Beer-Lambert Law to the first material based on one or more of: an absorptivity of the first material, the distance between the first plane and the first 3D graphical object, and the adjustable density value for the first material.

In some embodiments, the virtual environment comprises an extended reality (XR) virtual environment, wherein, e.g., the virtual environment may further comprises a system-level layer, upon which one or more application-level layers may be rendered. In some implementations, the optimized shaders described herein may be utilized within the aforementioned system-level layer.

Also disclosed herein is a method of graphical rendering, comprising: obtaining a first 3D graphical object, wherein the first 3D graphical object is associated with at least a first material (e.g., fog, mist, water, cloud, dust, or particles), wherein the first material comprises a 3D volume with an adjustable position within a virtual environment, and wherein the first material is associated with an adjustable density value and a 3D noise texture (e.g., a tiling 3D volume); determining a transparency value based, at least in part, on values within the 3D noise texture between a first viewpoint and the first 3D graphical object; and rendering, from the first viewpoint and using a first shader, at least a portion of the first 3D graphical object in the virtual environment by applying the determined transparency value to the first material.

According to some such embodiments, the first 3D graphical object is further associated with a second material, and wherein the rendering of at least a portion of the first 3D graphical object in the virtual environment further comprises blending between the first material and the second material according to the determined transparency value.

According to other such embodiments, the rendering of at least a portion of the first 3D graphical object in the virtual environment further comprises, for one or more rendered pixels of the first 3D graphical object: (a) computing a first plurality of points along a first ray emanating from the first viewpoint and terminating at a respective rendered pixel of the first 3D object, wherein at least a part of the first ray passes through the 3D volume, and wherein the first ray intersects with the first 3D object at an intersection point; (b) computing an integration value based on noise values corresponding to locations of each of the first plurality of points within the 3D noise texture and the adjustable density value; (c) determining based, at least in part, on the computed integration value, a first transparency value to apply to the first material at the intersection point; and (d) rendering a portion of the first 3D graphical object at the intersection point based, at least in part, on the determined first transparency value, the first material, and a portion of the second material corresponding to the first 3D graphical object at the intersection point.

In some such embodiments, computing the integration value further comprises computing a summation of: the adjustable density value multiplied by noise values corresponding to locations of each of the first plurality of points within the 3D noise texture.

Also disclosed herein are devices comprising at least a memory and one or more processors configured to perform any of the methods described herein. Further disclosed herein are non-transitory computer-readable media that store instructions that, when executed, cause the performance of any of the methods described herein.

### Exemplary Extended Reality (XR) Devices

A person can interact with and/or sense a physical environment or physical world without the aid of an electronic device. A physical environment can include physical features, such as a physical object or surface. An example of a physical environment is a physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly- or partially-simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, wearable device, or the like) and adjust graphical content (e.g., foreground objects, background objects, and/or other objects of interest in a given implementation) and/or auditory content presented to the user—e.g., similarly to how such views and sounds would change in a physical environment. In some situations, the XR system can adjust characteristic(s) of graphical content in response to other inputs, such as a representation of a physical motion (e.g., a vocal command), the passage of time or other system settings parameters, as will be explained in greater detail below.

Many different types of electronic systems can enable a user to interact with and/or sense an XR environment. A non-exclusive list of examples includes: heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment.

A head mountable system may also have a transparent or translucent display, rather than an opaque display. The transparent or translucent display can have a medium through which light is directed to a user's eyes. The display may utilize various display technologies, such as ULEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies, can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming—but would nevertheless be a routine undertaking for those of ordinary skill in the design and implementation of graphics rendering systems, having the benefit of this disclosure.

### Exemplary 3D Graphical Rendering Operations Involving Semi-Transparent Materials

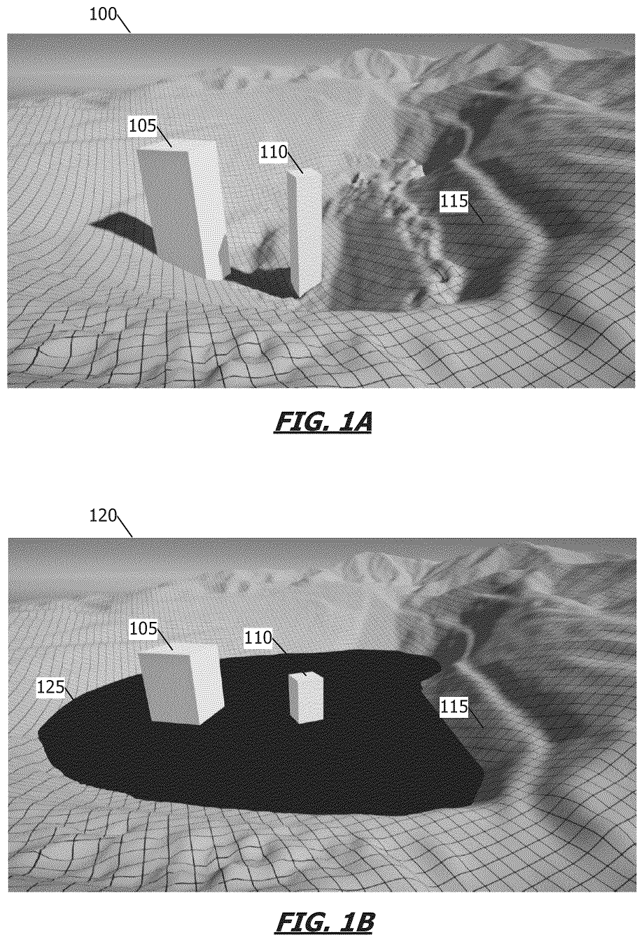

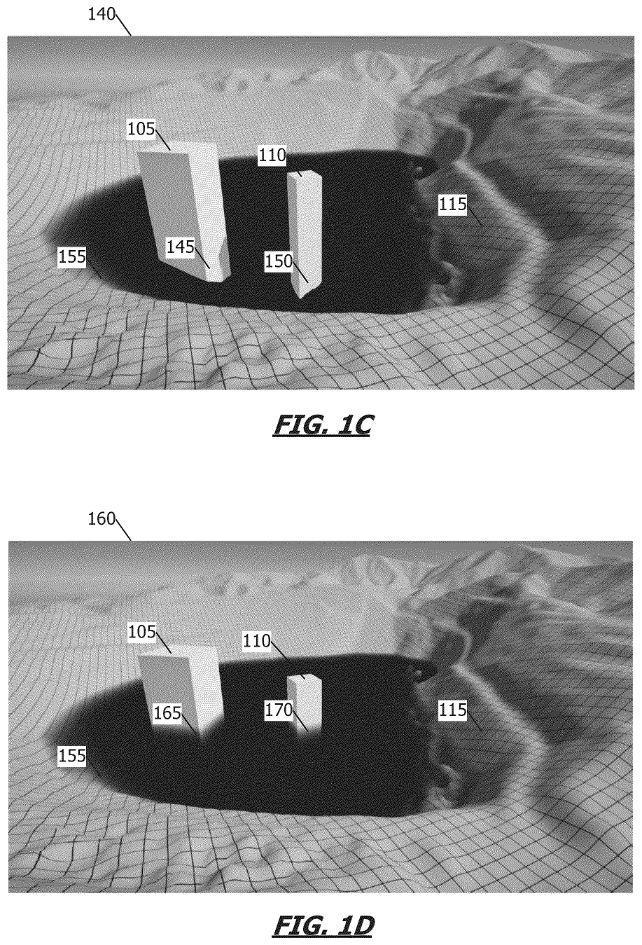

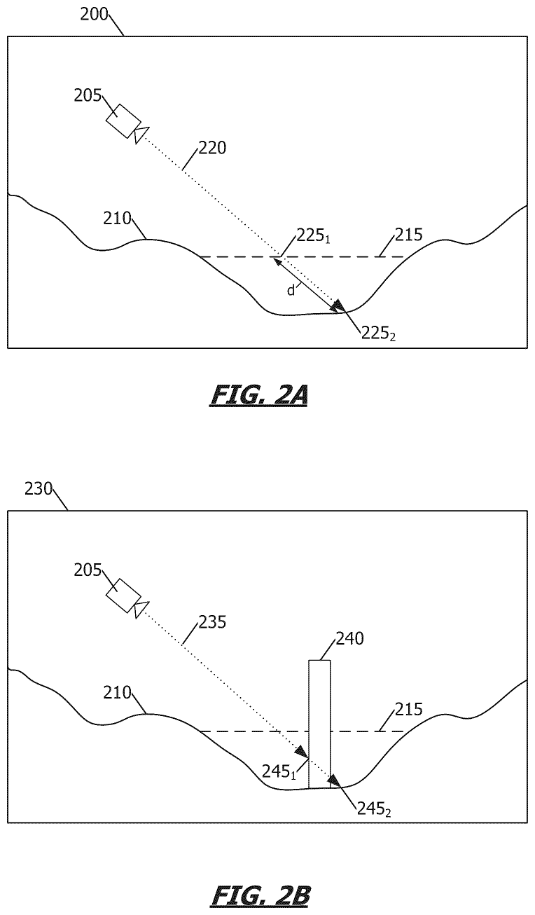

Referring now to FIG. 1A, an output of an opaque rendering pass of an exemplary scene 100 is shown. Exemplary scene 100 contains several common components, which will be discussed in the context of FIGS. 1A-1D. For example, pillars 105 and 110 in scene 100 are located in a virtual “lakebed” that is part of a terrain 115 that is to be rendered in the 3D virtual environment. Notably, pillars 105 and 110 are associated with a material that provides them with a solid white appearance, while terrain 115 is associated with a different material that provides the terrain with the darker, square grid-like appearance.

In traditional rendering, each of the opaque objects in the rendered scene may be drawn together in a first “opaque pass.” In some implementations, the output of the opaque pass may comprise a set of textures, e.g.: (1) a color texture containing the rendered color values for all the rendered pixels of the opaque objects; and (2) a depth texture containing depth values for all of the rendered pixels of the opaque objects. In some implementations, the depth texture may be encoded as a 2D array of continuous values, e.g., from 0.0 to 1.0, for each rendered pixel, wherein, e.g., a depth value of 0.0 (or black) corresponds to objects at the near clipping plane (i.e., the closest depth to the camera viewpoint that will be rendered), and a depth value of 1.0 (or white) corresponds to objects at the far clipping plane (i.e., the farthest depth from the camera viewpoint that will be rendered).

The transparent objects (or, more accurately, objects that are at least semi-transparent) in the scene are then rendered in a second “transparent pass” operation. In such implementations, a semi-transparent planar water surface, such as the water surface 155 illustrated in FIGS. 1C and 1D, may be rendered on top of the already existing opaque objects' colors and textures. Because the shader in such implementations would have access to the opaque objects color and depth textures, complex blending effects are possible such as shown around the edges of the water surface 155 illustrated in FIGS. 1C and 1D, wherein portions of the lakebed terrain are at least partially visible in the final render around the shallower, outer portions of the lake, while portions of the lakebed terrain are not visible in the final render around the deeper, inner portions of the lake, which leads to a more realistic look for the semi-transparent water material in the final render.

Turning now to FIG. 1B, an output 120 of an opaque rendering pass of an exemplary scene 100 that includes a planar water material is shown. In the example of FIG. 1B, an alternative to the complex (and computationally expensive) multi-pass rendering operations described above to realistically render semi-transparent materials on top of opaque materials in a rendered scene is shown. In the example output 120 of FIG. 1B, the planar water surface 125 is rendered in the opaque pass with the other opaque objects, such as pillars 105 and 110. An approach such as that illustrated in FIG. 1B would be computationally cheaper than a multi-pass rendering solution, due to the fact that the water surface 125 could be rendered before the color and depth textures were generated. However, the water surface 125 also would have no information about the 3D geometry of the terrain surface that is “behind” (or “beneath”) the water level, and, thus, the shader would not be able to perform the more realistic blending techniques between the water material and the terrain behind it, such as those referred to above regarding the edges of the water surface 155 illustrated in FIGS. 1C and 1D being partially transparent to reflect the shallow depth of the lake.

Turning now to FIG. 1C, an output 140 of a single-pass rendering operation that applies an optimized transparency-aware shader to the terrain 115, but not to the other 3D objects 105/110 in the exemplary scene 100, is shown. As will be discussed in further detail below, according to some embodiments disclosed herein, an optimized transparency-aware shader may be used to apply various semi-transparent materials to opaque 3D objects in the virtual environment in a single pass operation, while emulating the realistic visual effects achieved using a traditional multi-pass rendering operation that renders opaque objects and transparent objects in separate passes.

Thus, as alluded to above, the edges of the water surface 155 illustrated in FIG. 1C exhibit an appropriate amount of transparency in the blending between the “virtual” planar water material and the underlying terrain 115 (i.e., the virtual planar water material becomes less and less transparent as the distance between the planar water material and the bottom of the lakebed, i.e., the water depth, increases). However, one clear drawback of a naïve approach to this single-pass rendering operation is that, because the optimized transparency-aware shader is only shading the 3D geometry of the lakebed underneath the virtual planar water surface (i.e., there is no actual water plane mesh present in the virtual scene, in this example), any opaque object (e.g., pillars 105/110) placed below the virtual planar water surface will break the realistic rendering effect (see, e.g., the white areas 145/150 near the bases of pillars 105/110, respectively, in FIG. 1C, which should actually also be “behind” the virtual planar water surface in the rendered scene in order to appear physically realistic) if such opaque objects do not also use the optimized transparency-aware shader to apply the virtual planar water surface material to themselves.

Turning now to FIG. 1D, an output 160 of a single-pass rendering operation that applies an optimized transparency-aware shader to the terrain 115, as well as to the other 3D objects 105/110 in the exemplary scene 100, i.e., in order to better emulate a multi-pass rendering operation, is shown, according to one or more embodiments. In contrast to the example described above in FIG. 1C, in the output 160 of FIG. 1D, the optimized transparency-aware shader is applied to the terrain 115, as well as the other opaque object (e.g., pillars 105/110) in the scene. Thus, all portions of the terrain and/or the pillars that are located below the virtual planar water surface (e.g., area 165, in the case of pillar 105, and area 170, in the case of pillar 110) will be seamlessly blended with the virtual planar water surface (i.e., based on the “depth” of the virtual water plane in front of the opaque objects at any rendered pixel position) to provide a physically realistic look to the water surface—even though there is no actual 3D water mesh present in the scene, and the rendering of the semi-transparent water material takes place in the same pass as the rendering of the opaque objects in the scene.

It is to be understood that, if so desired, in order to add even more “realism” to the appearance of the surface of a water-based material, certain embodiments may sample a variety of normal map textures (e.g., scrolling normal map textures) and then use them to sample a reflection cube map to compute the colors for the water-based material. Various textures may also be sampled in order to compute the color to be used for the terrain/other 3D objects that are located beneath/behind the semi-transparent water-based material. In other words, the materials used for both the semi-transparent and opaque materials in a given rendered scene can be more complicated than a single, solid color/texture (as shown on the objects in FIGS. 1A-1D), if so desired.

Exemplary Ray Intersection with Planar and 3D Volumetric Semi-Transparent Materials in a Virtual Environment

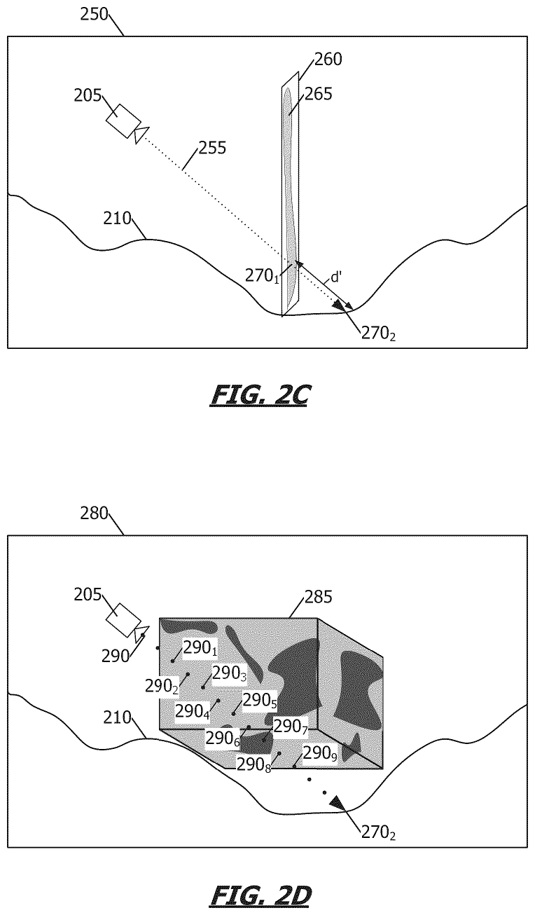

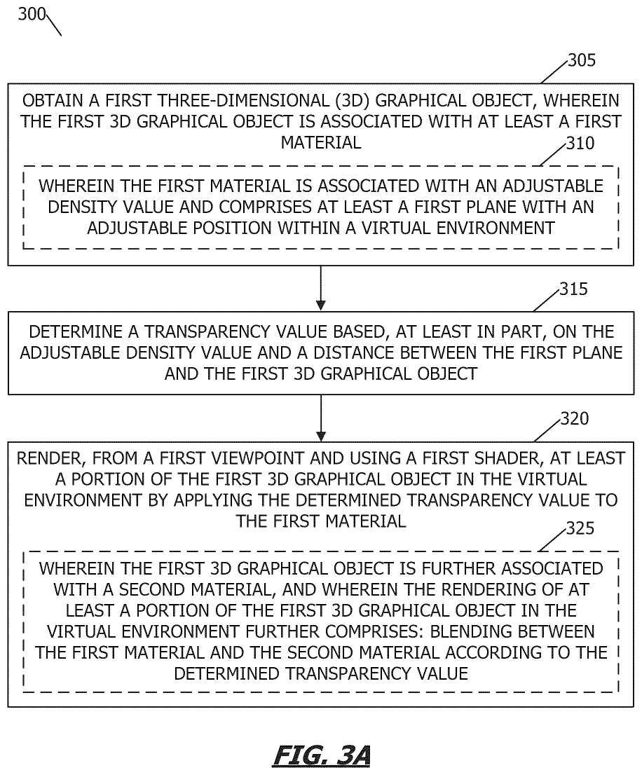

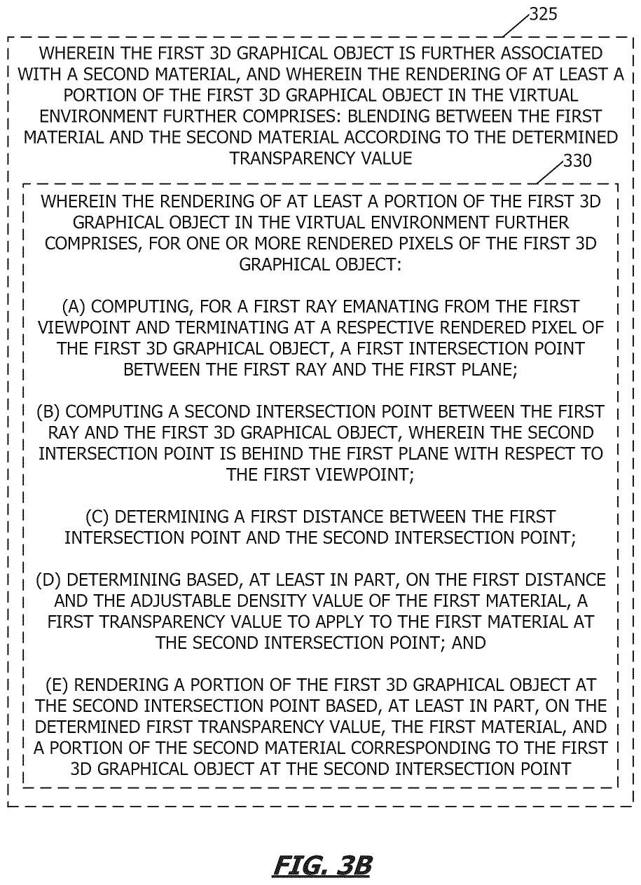

Referring now to FIG. 2A, an example 200 of a rendering operation that computes where an exemplary ray 220 emanating from a camera viewpoint 205 intersects with a semi-transparent, planar water material 215 is shown, according to one or more embodiments. As described above in the examples of FIGS. 1A-1D, the exemplary scene in example 200 includes a terrain material 210 that forms a lakebed lying, in part, below a virtual planar water material 215 surface that may be applied to various objects in the virtual environment. Exemplary ray 220 emanating from a camera viewpoint 205 intersects with a semi-transparent, planar water material 215 at a first intersection point (2251), and then the exemplary ray 220 continues until intersecting with the opaque terrain 210 surface at a second intersection point (2252).

According to some enhanced, single-pass rendering embodiments described herein, the distance (labeled “d,” in FIG. 2A) between the first intersection point (2251) and second intersection point (2252) may be calculated for each ray emanating from the camera viewpoint 205 to a rendered pixel of opaque terrain 210. This distance measure, d, may then be used, for any given ray, to determine a transparency value to apply to the water material in a blending operation when rendering the terrain 210 at the second intersection point (2252).

Generally speaking, the greater distance of a material (e.g., water) that light has to travel through (and the more dense or absorptive that material happens to be), the more the light will be attenuated by the time it reaches the end of its path. By calculating the distance measure, d, the rendering operation can thus determine an appropriate amount of transparency to apply to the material (e.g., making the water nearly transparent when the distance of water through which the light travels to reach the opaque object is quite small, and making the water fully opaque when the distance of water through which the light travels to reach the opaque object is large, as described above with reference to FIGS. 1C-1D).

According to the Beer-Lambert Law (also called “Beer's Law”), which, for materials with constant absorption coefficients, may be written as A=εbC, wherein the attenuation or absorbance (A) of light traveling through a material is directly proportional to the properties of the material through which the light is travelling (also referred to herein as an “attenuating material”), wherein & refers to the molar attenuation coefficient or absorptivity of the attenuating material, b refers to the length of the light path through the attenuating material, and C refers to the concentration (e.g., density) of the attenuating material. Thus, pre-determined and/or adjustable values may be plugged in to the Beer's Law equation for the values of ε (absorptivity of the attenuating material) and C (concentration/density of the attenuating material) depending on what the material is (e.g., water or fog or smoke or mist, etc.), and the distance measure, d, may be used for the value of b in the Beer's Law equation, given above. Beer's Law may also be evaluated in terms of transmittance, wherein transmittance (T) is equal to e\hat{ }(−opticalDepth), wherein opticalDepth is the integration of the absorption coefficients along the light ray. As alluded to above, for materials with constant absorption coefficients, this equation may also reduce to: T=e\hat{ }(−rayLength*absorptionCoefficient). For materials with non-constant absorption properties, however, an integral must be computed, as will be described in further detail, below.

Once it has been estimated how much of the light will be absorbed by the semi-transparent material, e.g., according to Beer's Law, a blending operation (e.g., a simple linear or alpha blending operation, or the like) may be used to blend between the semi-transparent material and the other material(s) that have been applied to the opaque object at the point of intersection with the opaque object. As used herein, the term “alpha blending” refers to a computational image synthesis problem of composing video image signals with two or more layers. For example, a given image, I, may be represented by the following alpha blending equation: I=αF+(1−α)B, where F is the foreground layer, B is the background layer, and α is the alpha value (e.g., a continuous value within the range 0.0 to 1.0). For example, if, when ray 220 reaches the lakebed intersection point 2252, Beer's Law determines that 90% of the light ray would have been attenuated by the light traveling the distance, d, “through” the water material, then the rendering operation may calculate a value for the intersection point 2252 that is a blending of 90% of the color of the water material and 10% the color of the terrain material at intersection point 2252. Conversely, if Beer's Law were to determine that only 10% of the light ray would have been attenuated by the light traveling the distance, d, through the water material, then the rendering operation may calculate a value for the intersection point 2252 that is a blending of 10% of the color of the water material and 90% the color of the terrain material at intersection point 2252. As may now be appreciated, one technical effect of these embodiments is that the computational cost of performing a separate transparency pass is avoided in the rendering operation, while still emulating a physically-realistic representation of the semi-transparent materials within the rendered scene.

In some embodiments, determining the transparency value may be further based, at least in part, on a current value of a time-of-day variable for the virtual environment (or other system variable that may impact the color, character, or intensity of the light being projected in the virtual environment and/or the density, absorption colors, reflectance, or other properties of any semi-transparent materials in the virtual environment). In some embodiments, a time-of-day variable (or other of the individual light or material properties, as mentioned above) may also be individually adjustable via a programmatic interface and/or user-accessible interface element, such as sliders, dials, or the like. In some implementations, it may be desirable to provide transition periods, wherein the light or material properties mentioned above may gradually transition from a first value to a second value over a determined transition time period, to reduce any jarring visual effects that may be experienced by a user.

Referring now to FIG. 2B, an example 230 of a rendering operation that computes where an exemplary ray 235 emanating from a camera viewpoint 205 intersects with a 3D object 240 that is unaware of a semi-transparent, planar water material at an intersection point 2451 is shown. As mentioned above, if the optimized transparency-aware shaders disclosed herein are used to apply the semi-transparent planar materials to the terrain—but not to the other 3D objects in the exemplary scene—the desired effect will quickly breakdown, especially if there are parts of the 3D objects in the scene that are below the semi-transparent planar material (in this case, represented by water plane 215). More particularly, because the shader is actually shading the geometry under the “virtual” water surface 215, any opaque object that is placed in front of the terrain will break the realistic semi-transparency effect, unless that opaque object is also using an optimized transparency-aware shaders.

In other words, in the example of FIG. 2B, because the intersection point 2451 on the left side of the opaque pillar “blocks” what would have been the camera's view of the intersection point 2452 of the ray 235 with the lakebed terrain 210, even if the terrain 210 is using an optimized transparency-aware shader to give an appropriate amount of blending influence to the planar water material, the beneficial effect of the optimized transparency-aware shaders will not be experienced because the camera's viewpoint is blocked by intersection point 2451 of pillar 240, which, in this example, is not using an optimized transparency-aware shader and thus unaware of the semi-transparent, planar water material 215. This scenario will result in pillar 240 being rendered with the undesirable rendering effect described above with reference to areas 145/150 near the bases of pillars 105/110, respectively, in FIG. 1C. Thus, FIG. 2B simply illustrates the point that, to ensure the beneficial effects of the optimized transparency-aware shaders are realized, each 3D object in the scene—where even a portion of the object may be located below/behind a semi-transparent material—should be utilizing the optimized transparency-aware shaders described herein.

Referring now to FIG. 2C, an example 250 of a rendering operation that computes where an exemplary ray 255 emanating from a camera viewpoint 205 intersects with a semi-transparent, planar fog/cloud material 265 is shown, according to one or more embodiments. As may now be appreciated, the example 250 of FIG. 2C is analogous to the example 200 of FIG. 2A, except that the horizontal semi-transparent, planar water material 215 of FIG. 2A has been rotated by 90 degrees into the vertical semi-transparent, plane 260 composed of a representative fog/cloud material 265 of FIG. 2C.

As in the examples described above (e.g., FIG. 2A) with regard to horizontal semi-transparent water planes, Beer's Law (or other modeling equations) may be used to determine an appropriate transparency level to apply to the fog/cloud material 265 that is modeled as being at the location of plane 260. It is to be understood that the fog/cloud material 265 could have a different density, absorptivity, etc. than that of water, so that the determined transparency values would present a rendering that was more physically realistic to the effects of fog, clouds (or whatever other semi-transparent material is desired to be rendered in a given virtual environment).

As shown in FIG. 2C, according to some single-pass rendering embodiments described herein, the distance (labeled d′ in FIG. 2C) between a first intersection point (270₁) of ray 255 and the plane 260, as well as a second intersection point (270₂) of ray 255 and the opaque surface (e.g., lakebed terrain 210 in FIG. 2C) behind plane 260 may be calculated for each ray emanating from the camera viewpoint 205. This distance measure, d′, may then be used, for any given ray, to determine a transparency value to apply to the fog/cloud material 265 in a blending operation when rendering the terrain 210 at the second intersection point (270₂).

As mentioned above, the more of a material (e.g., fog/cloud material 265) that light has to travel through (and the more dense or absorptive that material happens to be), the more the light will be attenuated by the time the light reaches the end of its path. By calculating the distance measure, d′, the rendering operation can thus determine an appropriate amount of transparency to apply to the material (e.g., making the fog/cloud nearly transparent when the distance of fog/cloud through which the light travels to reach the opaque object is quite small, and making the fog/cloud much more opaque when the distance of fog/cloud through which the light travels to reach the opaque object is large).

While the examples described above with reference to FIGS. 2A-2C contemplate modeling a semi-transparent material as a planar surface in a virtual scene (e.g., a horizontal water plane, a vertical fog/cloud plane, etc.), other embodiments may take a different approach to attempt to more realistically model the effects of light traveling through a semi-transparent material. For example, the semi-transparent material may be modeled as a 3D volume made of an absorptive, semi-transparent material (e.g., with randomly-distributed density values throughout the 3D volume to simulate the non-constant volumetric density of actual fog, clouds, etc.).

It is also to be understood that the techniques of FIG. 2A and FIG. 2C may operate in a complementary fashion within a virtual environment. For example, a given single-pass rendering operation in an exemplary virtual environment may be able to model, emulate, and render more than one semi-transparent transparent material for a given camera ray (e.g., ray 220 or 255). For example, in one implementation, a single-pass rendering operation may render the presence of each of: a fog/cloud material (such as 265), a water material (such as 215), and a terrain (such as 210) for a particular rendered pixel (e.g., if the ray that is being rendered passes first through a planar cloud material, then through the surface of planar water material, and then terminates at a terrain). In such implementations, the two-variable linear blending equations described above may be expanded to compute a contribution factor for each such additional material (i.e., beyond two) that the ray passes through, e.g., based on each material's respective density, absorption properties, thickness, etc.

Referring now to FIG. 2D, an example 280 of a rendering operation that computes where an exemplary ray 290 emanating from a camera viewpoint 205 intersects at multiple points (290n) with a semi-transparent, 3D volumetric fog/cloud material 285 is shown, according to one or more embodiments. The different degrees of shading within 3D volumetric fog/cloud material 285 in FIG. 2D are intended to illustrate different densities (or concentrations) of the fog/cloud material throughout different locations within the 3D volume. According to some embodiments, the 3D volume may have an adjustable position within the virtual environment (e.g., 3D volumetric fog/cloud material 285 in FIG. 2D is shown as largely “hovering” over the lakebed, but the position of this 3D volume could be shifted up, down, left, right, elongated, etc., as desired for a given implementation).

According to other embodiments, the 3D volume may also be associated with a 3D noise texture (wherein, e.g., the 3D noise texture specifies a randomized noise value for each point within the 3D volume), wherein the density value for the semi-transparent material 285 may be computed at any given point within the 3D volume by multiplying an adjustable density value (e.g., also referred to herein as a “baseline” density value for the semi-transparent material) by the corresponding noise value of the given point within the 3D noise texture.

In some such embodiments, the 3D noise texture may preferably comprise a tiling 3D volume, wherein “tiles” of randomly-determined noise values are repeated and extended across the 3D volume to ensure that each point in the 3D volume is assigned some random noise value. It is to be understood that the mean and/or standard deviation of the noise function used to generate the 3D noise texture values may be modified as needed, e.g., in order to simulate the particle concentration and/or variance in density of particles within the particular semi-transparent material 285 that is being simulated in a given virtual environment.

According to embodiments such as example 280 of FIG. 2D, wherein a 3D volume of non-uniform density is utilized to approximate the semi-transparent material in the virtual environment, the simplified form of Beer's Law described above in the context of FIGS. 2A and 2C (wherein a constant concentration/density of the attenuating material throughout the path of the light ray through the semi-transparent material is assumed) may not be able to provide a sufficiently accurate determination of a transparency value to apply to the semi-transparent material at the real geometry shading point (i.e., point 270₂ in FIG. 2D). Instead, such embodiments employing 3D volume representations of semi-transparent materials may compute a first plurality of points (e.g., points 290₁-290₉ in FIG. 2D) along a first ray 290 emanating from the viewpoint 205 and terminating at a respective rendered pixel of an opaque 3D object beneath or behind the 3D volume (i.e., point 270₂ in FIG. 2D). As shown in FIG. 2D, at least a part of the first ray 290 passes through the 3D volume 285. According to such embodiments, an integration value may be computed based on the respective noise values corresponding to locations of each of the first plurality of points (e.g., 290₁-290₉) within a 3D noise texture that is associated with the 3D volume 285 and the adjustable or “baseline” density value for the semi-transparent material.

In particular, according to some embodiments, the integration value may be determined by computing a summation of the adjustable or “baseline” density value multiplied by the respective noise values corresponding to locations of each of the first plurality of points within the 3D noise texture. For example, in the case of FIG. 2D, the integration value may be computed as: (density_{baseline}*noise_val_{290_1})+(density_{baseline}*noise_val_{290_2})+(density_{baseline}*noise_val_{290_3}) . . . and so forth, for each point along the ray 290 that is being sampled within the 3D volume 285. This sum may then be divided by the number of points sampled along the ray. (It is to be understood that the sampling density of a given ray, i.e., the number of points 290n for which values are sampled, may affect how much weight any individual point contributes to the overall computed integration value for the given ray.)

As with the embodiments described above, e.g., with reference to FIGS. 2A and 2C, the final computed integration value may be used to determine a first transparency value to apply to the semi-transparent material at the real geometry shading point (i.e., point 270₂ in FIG. 2D). For example, the more density of the semi-transparent material that is “accumulated” along the ray's path through the 3D volume (i.e., the higher the computed integration value), the less influence the material of the terrain at the real geometry shading point (i.e., point 270₂ in FIG. 2D) will have in the final blending operation that is used to compute the rendered color value of the real geometry shading point (270₂). That is, the rendered color value in such a scenario will be dominated by the color of the semi-transparent material. By contrast, the less density of the semi-transparent material that is accumulated along the ray's path through the 3D volume, the greater the influence of the material of the terrain at the real geometry shading point itself (i.e., point 270₂ in FIG. 2D) will be. That is, the color of the semi-transparent material in such a scenario will have less effect on the final rendered color value of the real geometry shading point.

### Exemplary Shader Operations for Rendering Semi-Transparent Materials

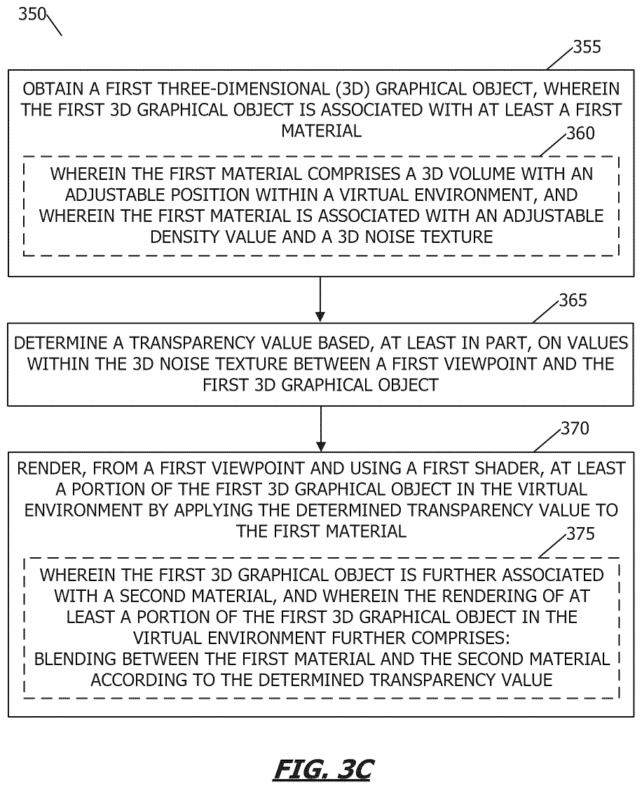

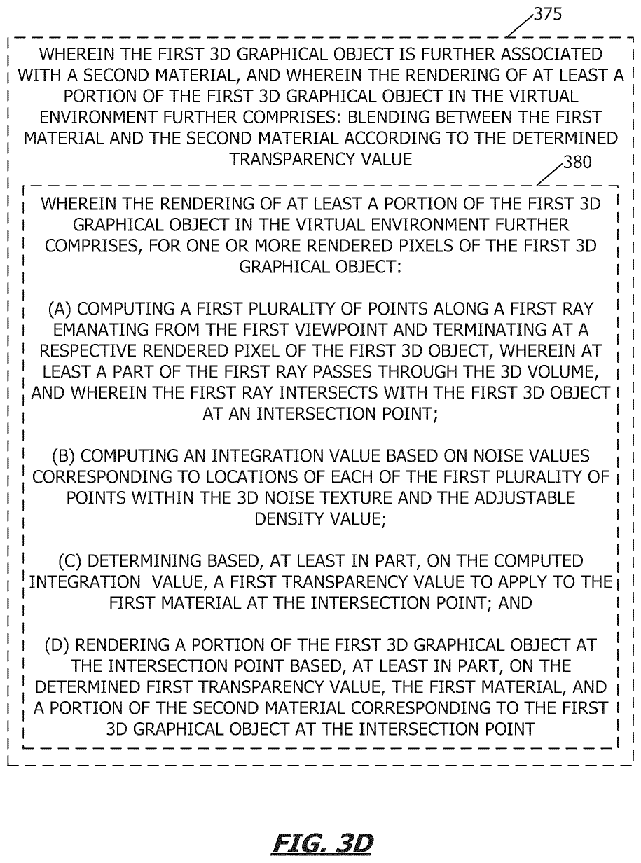

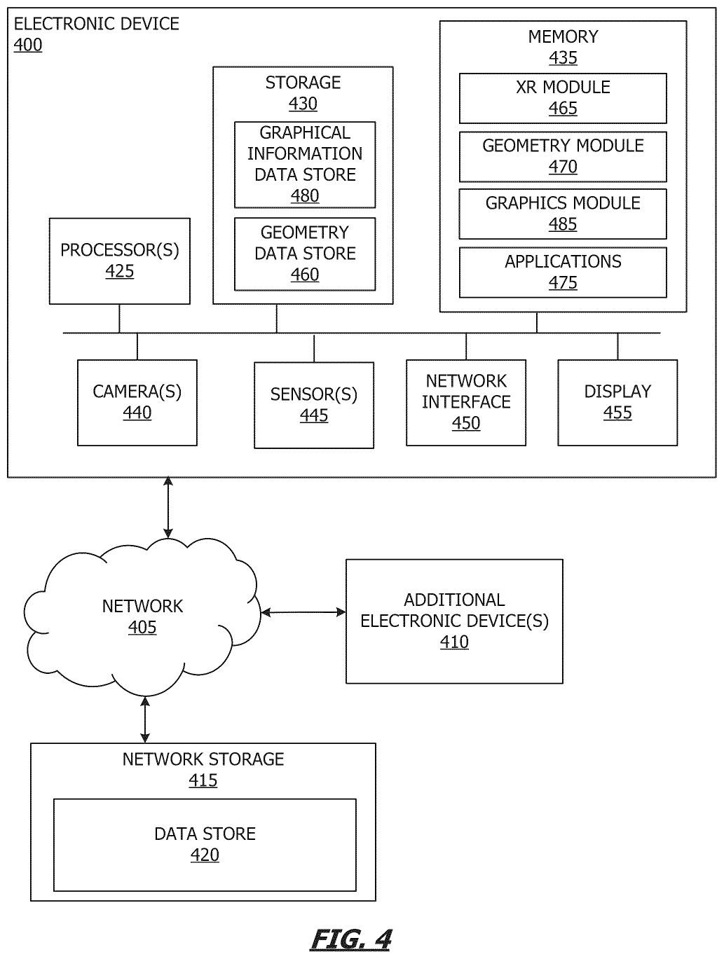

Referring now to FIG. 3A, a flowchart 300 of a technique for rendering opaque and semi-transparent 3D objects in a single rendering pass using a planar, semi-transparent material (as also illustrated in FIGS. 2A-2C) is shown, according to one or more embodiments. First, at step 305, the method 300 may obtain a first 3D graphical object, wherein the first 3D graphical object is associated with at least a first material. In some implementations, as shown at step 310, the first material may be associated with an adjustable density value and may comprise at least a first plane with an adjustable position within a virtual environment (e.g., an adjustable height, an adjustable x/y position in a virtual environment, an angle of rotation with respect to a defined x-y plane in the virtual environment, etc.).

Next, at step 315, the method 300 may determine a transparency value based, at least in part, on the adjustable density value associated with the first material and a distance between the first plane and the first 3D graphical object. As described above, in some embodiments, an implementation of the Beer-Lambert Law equation may be used to transform: the density value for the first material; an assumed absorptivity for the first material; and the distance between the “virtual” first plane and the 3D graphical object into the determined transparency value to be applied to the first material in the single-pass rendering operation.

At step 320, the method 300 may render, from a first viewpoint and using a first shader, at least a portion of the first 3D graphical object in the virtual environment by applying the determined transparency value to the first material. For example, as illustrated at step 325, the first 3D graphical object may be further associated with a second material, and the rendering of at least a portion of the first 3D graphical object in the virtual environment may further comprise blending between the first material and the second material according to the determined transparency value (e.g., according to a linear or alpha blend, or the like).

Turning now to FIG. 3B, further details are given regarding some implementations of step 325 of FIG. 3A. In particular, at step 330, it is shown that, according to some implementations, the rendering of at least a portion of the first 3D graphical object in the virtual environment further comprises, for one or more rendered pixels of the first 3D graphical object: (a) computing, for a first ray emanating from the first viewpoint and terminating at a respective rendered pixel of the first 3D graphical object, a first intersection point between the first ray and the first plane; (b) computing a second intersection point between the first ray and the first 3D graphical object, wherein the second intersection point is behind the first plane with respect to the first viewpoint; (c) determining a first distance between the first intersection point and the second intersection point; (d) determining based, at least in part, on the first distance and the adjustable density value of the first material, a first transparency value to apply to the first material at the second intersection point; and then (c) rendering a portion of the first 3D graphical object at the second intersection point based, at least in part, on the determined first transparency value, the first material, and a portion of the second material corresponding to the first 3D graphical object at the second intersection point.

It is to be understood that the computing of rays emanating from the first viewpoint may be repeated iteratively for each pixel that will be rendered for the first 3D graphical object. However, not all rays emanating from the first viewpoint will necessarily intersect with the first plane (e.g., if the first material is a water level plane having a height of Z=100 pixels in the virtual environment, then pixels of the first 3D graphical object having a Z value of greater than 100 within the first viewpoint may not actually be located “behind” the first material plane, with respect to the current first viewpoint), and, thus, such pixels on the surface of the first 3D graphical object may not need to have the specialized single-pass semi-transparent material rendering operations described herein applied to them during the rendering operation (i.e., only the material of the first 3D graphical object itself will be relevant to the rendering operation, and the rendering pass may use traditional opaque rendering techniques for such pixels).

Turning now to FIG. 3C, a flowchart 350 of a technique for rendering opaque and semi-transparent 3D objects in a single rendering pass using a semi-transparent 3D volumetric material (as also illustrated in FIG. 2D) is shown, according to one or more embodiments. First, at step 355, the method 350 may obtain a first 3D graphical object, wherein the first 3D graphical object is associated with at least a first material. In some implementations, as shown at step 360, the first material may comprise a 3D volume with an adjustable position (e.g., specified by one or more x-y-z-axial coordinates and/or dimensions) within a virtual environment, and wherein the first material is associated with an adjustable density value and a 3D noise texture (e.g., wherein each point in the 3D noise texture has a corresponding location and point in the 3D volume).

Next, at step 365, the method 300 may determine a transparency value based, at least in part, on values within the 3D noise texture between a first viewpoint and the first 3D graphical object. As described above, in some embodiments, an integration operation may be performed by applying the values in the 3D noise texture to corresponding points on a ray emanating from a camera viewpoint, passing through the 3D volume, and terminating at the first 3D graphical object to determine the transparency value that is to be applied to the first material in the rendering operation.

At step 370, the method 350 may render, from a first viewpoint and using a first shader, at least a portion of the first 3D graphical object in the virtual environment by applying the determined transparency value to the first material. For example, as illustrated at step 375, the first 3D graphical object may be further associated with a second material, and the rendering of at least a portion of the first 3D graphical object in the virtual environment may further comprise blending between the first material and the second material according to the determined transparency value (e.g., according to a linear or alpha blend, or the like).

Turning now to FIG. 3D, further details are given regarding some implementations of step 375 of FIG. 3C. In particular, at step 380, it is shown that, according to some implementations, rendering of at least a portion of the first 3D graphical object in the virtual environment further comprises, for one or more rendered pixels of the first 3D graphical object: (a) computing a first plurality of points along a first ray emanating from the first viewpoint and terminating at a respective rendered pixel of the first 3D object, wherein at least a part of the first ray passes through the 3D volume, and wherein the first ray intersects with the first 3D object at an intersection point; (b) computing an integration value based on noise values corresponding to locations of each of the first plurality of points within the 3D noise texture and the adjustable density value; (c) determining based, at least in part, on the computed integration value, a first transparency value to apply to the first material at the intersection point; and (d) rendering a portion of the first 3D graphical object at the intersection point based, at least in part, on the determined first transparency value, the first material, and a portion of the second material corresponding to the first 3D graphical object at the intersection point.

It is to be understood that the computing of rays emanating from the first viewpoint may be repeated iteratively for each pixel that will be rendered for the first 3D graphical object. However, not all rays emanating from the first viewpoint and terminating at the first 3D graphical object will necessarily pass through the 3D volume (e.g., if the 3D volume is located exclusively above or below a particular ray), and, thus, such pixels on the surface of the first 3D graphical object may not need to have the specialized single-pass semi-transparent material rendering operations described herein applied to them during the rendering operation (i.e., only the material of the first 3D graphical object will be relevant to the rendering operation, and the rendering pass may use traditional opaque rendering techniques for such pixels).

### Exemplary Block Diagram

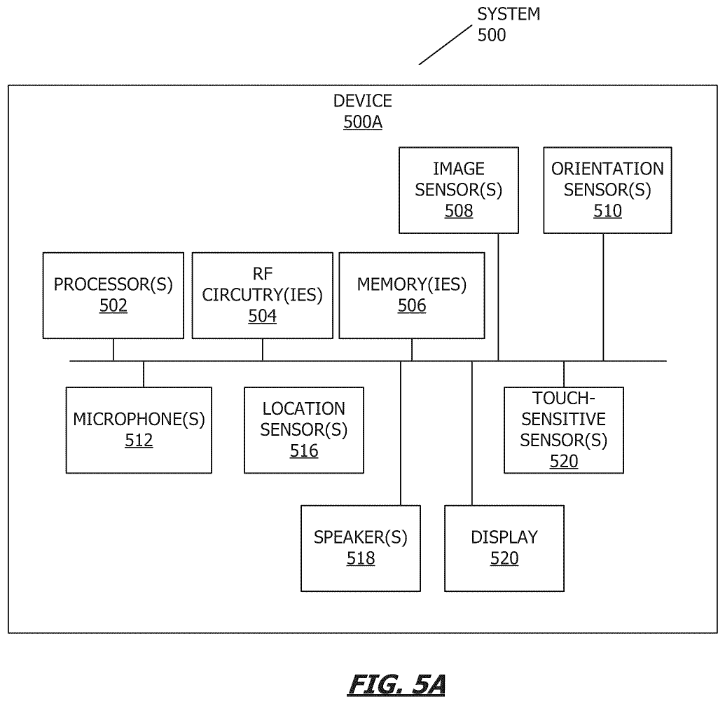

Referring now to FIG. 4, a simplified block diagram of an electronic device 400 is depicted, communicably connected to additional electronic devices 410 and a network storage 415 over a network 405, in accordance with one or more embodiments of the disclosure. Electronic device 400 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 400, additional electronic device 410, and/or network storage 415 may additionally, or alternatively, include one or more additional devices within which the various functionality may be contained, or across which the various functionality may be distributed, such as server devices, base stations, accessory devices, and the like. Illustrative networks, such as network 405 include, but are not limited to, a local network such as a universal serial bus (USB) network, an organization's local area network, and a wide area network such as the Internet. According to one or more embodiments, electronic device 400 may be utilized to participate in a single user or multiuser session in an XR environment. It should be understood that the various components and functionality within electronic device 400, additional electronic device 410 and network storage 415 may be differently distributed across the devices, or they may be distributed across additional devices.

Electronic Device 400 may include one or more processors 425, such as a central processing unit (CPU). Processor(s) 425 may include a system-on-chip such as those found in mobile devices and include one or more dedicated graphics processing units (GPUs). Further, processor(s) 425 may include multiple processors of the same or different type. Electronic device 400 may also include a memory 435. Memory 435 may include one or more different types of memory, which may be used for performing device functions in conjunction with processor(s) 425. For example, memory 435 may include cache, ROM, RAM, or any kind of transitory or non-transitory computer readable storage medium capable of storing computer readable code. Memory 435 may store various programming modules for execution by processor(s) 425, including XR module 465, geometry module 470, graphics module 485, and other various applications 475. Electronic device 400 may also include storage 430. Storage 430 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Electronic device may additionally include a network interface 450, from which the electronic device 400 can communicate across network 405.

Electronic device 400 may also include one or more cameras 440 or other sensors 445, such as depth sensor(s), from which depth or other characteristics of an environment may be determined. In one or more embodiments, each of the one or more cameras 440 may be a traditional RGB camera, or a depth camera. Further, cameras 440 may include a stereo- or other multi-camera system, a time-of-flight camera system, or the like. Electronic device 400 may also include a display 455. The display device 455 may utilize digital light projection, OLEDs, LEDS, ULEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Storage 430 may be utilized to store various data and structures which may be utilized for providing state information in order to manage geometry data for physical environments of a local user and/or a remote user. Storage 430 may include, for example, geometry data store 460. Geometry data store 460 may be utilized to store data related to one or more physical environments in which electronic device 400 participates, e.g., in a single user session or a multiuser session. For example, geometry data store 460 may store characteristics of a physical environment, which may affect available space for presentation of components (e.g., UI elements or other graphical components to be displayed in an XR environment) during a user session. As another example, geometry data store 460 may store characteristics of a physical environment, which may affect how a user is able to move around or interact with the physical environment around the device. Storage 430 may further include, for example, graphical information data store 480. Graphical information data store 480 may store characteristics of graphical information (e.g., material information, texture information, reflectivity information, depth information and/or color information) that may be composited and rendered in an image frame containing a representation of all or part of the user's physical environment. Additionally, or alternatively, geometry data and graphical information data may be stored and/or transmitted across network 405, such as by data store 420.

According to one or more embodiments, memory 435 may include one or more modules that comprise computer readable code executable by the processor(s) 425 to perform functions. The memory may include, for example, an XR module 465, which may be used to process information in an XR environment. The XR environment may be a computing environment which supports a single user experience by electronic device 400, as well as a shared, multiuser experience, e.g., involving collaboration with an additional electronic device(s) 410.

The memory 435 may also include a geometry module 470, for processing information regarding the characteristics of a physical environment, which may affect how a user moves around the environment or interacts with physical and/or virtual objects within the environment. The geometry module 470 may determine geometric characteristics of a physical environment, for example from sensor data collected by sensor(s) 445, or from pre-stored information, such as from geometry data store 460. Applications 475 may include, for example, computer applications that may be experienced in an XR environment by one or multiple devices, such as electronic device 400 and additional electronic device(s) 410. The graphics module 485 may be used, e.g., for processing information regarding characteristics of graphical information, including depth and/or color information, which may or may not be composited into an image frame depicting all or part of a user's physical environment)

Although electronic device 400 is depicted as comprising the numerous components described above, in one or more embodiments, the various components may be distributed across multiple devices. Accordingly, although certain processes are described herein, with respect to the particular systems as depicted, in one or more embodiments, the various processes may be performed differently, based on the differently-distributed functionality. Further, additional components may be used, some combination of the functionality of any of the components may be combined.

### Exemplary Electronic Devices

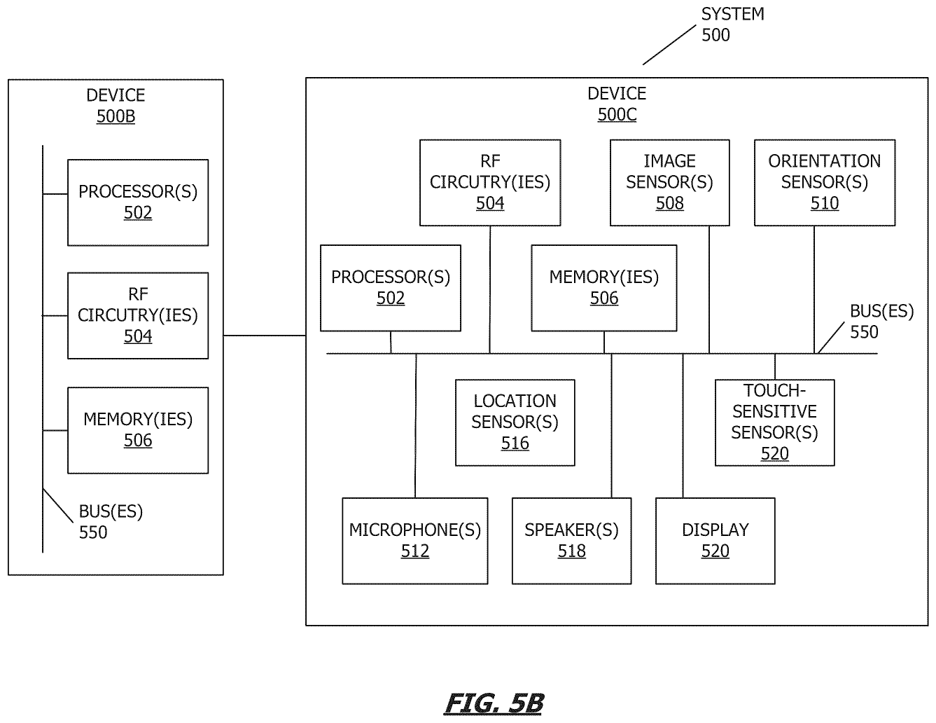

FIG. 5A and FIG. 5B depict exemplary system 500 for use in various extended reality (XR) technologies. In some examples, as illustrated in FIG. 5A, system 500 includes device 500A. Device 500A includes various components, such as processor(s) 502, RF circuitry(ies) 504, memory(ies) 506, image sensor(s) 508, orientation sensor(s) 510, microphone(s) 512, location sensor(s) 516, speaker(s) 518, display(s) 520, and touch-sensitive sensor(s) 522. These components optionally communicate over communication bus(es) 550 of device 500a.

In some examples, elements of system 500 are implemented in a base station device (e.g., a computing device, such as a remote server, mobile device, or laptop) and other elements of system 500 are implemented in a second device (e.g., a head-mounted device, or “HMD”). In some examples, device 500A is implemented in a base station device or a second device.

As illustrated in FIG. 5B, in some examples, system 500 includes two (or more) devices in communication, such as through a wired connection or a wireless connection. First device 500B (e.g., a base station device) includes processor(s) 502, RF circuitry(ies) 504, and memory(ies) 506. These components optionally communicate over communication bus(es) 550 of device 500C. Second device 500C (e.g., a head-mounted device, or “HMD”) includes various components, such as processor(s) 502, RF circuitry(ies) 504, memory(ies) 506, image sensor(s) 508, orientation sensor(s) 510, microphone(s) 512, location sensor(s) 516, speaker(s) 518, display(s) 520, and touch-sensitive sensor(s) 522. These components optionally communicate over communication bus(es) 550 of device 500C.

System 500 includes processor(s) 502 and memory(ies) 506. Processor(s) 502 include one or more general processors, one or more graphics processors, and/or one or more digital signal processors. In some examples, memory(ies) 506 are one or more non-transitory computer-readable storage mediums (e.g., flash memory, random access memory) that store computer-readable instructions configured to be executed by processor(s) 502 to perform the techniques described below.

System 500 includes RF circuitry(ies) 504. RF circuitry(ies) 504 optionally include circuitry for communicating with electronic devices, networks, such as the Internet, intranets, and/or a wireless network, such as cellular networks and wireless local area networks (LANs). RF circuitry(ies) 504 optionally includes circuitry for communicating using near-field communication and/or short-range communication, such as Bluetooth®.

System 500 includes display(s) 520. Display(s) 520 may have an opaque display. Display(s) 520 may have a transparent or semi-transparent display that may incorporate a substrate through which light representative of images is directed to an individual's eyes. Display(s) 520 may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one example, the transparent or semi-transparent display may transition selectively between an opaque state and a transparent or semi-transparent state. Other examples of display(s) 520 include heads up displays, automotive windshields with the ability to display graphics, windows with the ability to display graphics, lenses with the ability to display graphics, tablets, smartphones, and desktop or laptop computers. Alternatively, system 500 may be designed to receive an external display (e.g., a smartphone). In some examples, system 500 is a projection-based system that uses retinal projection to project images onto an individual's retina or projects virtual objects into a physical setting (e.g., onto a physical surface or as a holograph).

In some examples, system 500 includes touch-sensitive sensor(s) 522 for receiving user inputs, such as tap inputs and swipe inputs. In some examples, display(s) 520 and touch-sensitive sensor(s) 522 form touch-sensitive display(s).

System 500 includes image sensor(s) 508. Image sensors(s) 508 optionally include one or more visible light image sensor, such as charged coupled device (CCD) sensors, and/or complementary metal-oxide-semiconductor (CMOS) sensors operable to obtain images of physical elements from the physical setting. Image sensor(s) also optionally include one or more infrared (IR) sensor(s), such as a passive IR sensor or an active IR sensor, for detecting infrared light from the physical setting. For example, an active IR sensor includes an IR emitter, such as an IR dot emitter, for emitting infrared light into the physical setting. Image sensor(s) 508 also optionally include one or more event camera(s) configured to capture movement of physical elements in the physical setting. Image sensor(s) 508 also optionally include one or more depth sensor(s) configured to detect the distance of physical elements from system 500. In some examples, system 500 uses CCD sensors, event cameras, and depth sensors in combination to detect the physical setting around system 500. In some examples, image sensor(s) 508 include a first image sensor and a second image sensor. The first image sensor and the second image sensor are optionally configured to capture images of physical elements in the physical setting from two distinct perspectives. In some examples, system 500 uses image sensor(s) 508 to receive user inputs, such as hand gestures. In some examples, system 500 uses image sensor(s) 508 to detect the position and orientation of system 500 and/or display(s) 520 in the physical setting. For example, system 500 uses image sensor(s) 508 to track the position and orientation of display(s) 520 relative to one or more fixed elements in the physical setting.

In some examples, system 500 includes microphones(s) 512. System 500 uses microphone(s) 512 to detect sound from the user and/or the physical setting of the user. In some examples, microphone(s) 512 includes an array of microphones (including a plurality of microphones) that optionally operate in tandem, such as to identify ambient noise or to locate the source of sound in space of the physical setting.

System 500 includes orientation sensor(s) 510 for detecting orientation and/or movement of system 500 and/or display(s) 520. For example, system 500 uses orientation sensor(s) 510 to track changes in the position and/or orientation of system 500 and/or display(s) 520, such as with respect to physical elements in the physical setting. Orientation sensor(s) 510 optionally include one or more gyroscopes and/or one or more accelerometers.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3A-3D, or the arrangement of elements shown in FIGS. 4 and 5A-5B, should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method of graphical rendering, comprising:
obtaining a first three-dimensional (3D) graphical object, wherein the first 3D graphical object is associated with at least a first material, and wherein the first material is associated with an adjustable density value and comprises at least a first plane with an adjustable position within a virtual environment;
determining a transparency value based, at least in part, on the adjustable density value and a distance between the first plane and the first 3D graphical object; and
rendering, from a first viewpoint and using a first shader, at least a portion of the first 3D graphical object in the virtual environment by applying the determined transparency value to the first material.

2. The method of claim 1, wherein the first 3D graphical object is further associated with a second material, and wherein the rendering of at least a portion of the first 3D graphical object in the virtual environment further comprises:
blending between the first material and the second material according to the determined transparency value.

3. The method of claim 2, wherein the rendering of at least a portion of the first 3D graphical object in the virtual environment further comprises, for one or more rendered pixels of the first 3D graphical object:
(a) computing, for a first ray emanating from the first viewpoint and terminating at a respective rendered pixel of the first 3D graphical object, a first intersection point between the first ray and the first plane;
(b) computing a second intersection point between the first ray and the first 3D graphical object, wherein the second intersection point is behind the first plane with respect to the first viewpoint;
(c) determining a first distance between the first intersection point and the second intersection point;
(d) determining based, at least in part, on the first distance and the adjustable density value of the first material, a first transparency value to apply to the first material at the second intersection point; and
(e) rendering a portion of the first 3D graphical object at the second intersection point based, at least in part, on the determined first transparency value, the first material, and a portion of the second material corresponding to the first 3D graphical object at the second intersection point.

4. The method of claim 1, wherein the first plane comprises a horizontal plane, and wherein the adjustable position comprises an adjustable height within the virtual environment.

5. The method of claim 1, wherein the first plane further comprises a rotatable and scalable plane within the virtual environment.

6. The method of claim 1, wherein the first material comprises a semi-transparent material.

7. The method of claim 6, wherein the first material comprises at least one of: fog, mist, water, cloud, dust, or particles.

8. The method of claim 1, wherein the rendering of the first 3D graphical object in the virtual environment further comprises a single pass rendering operation that renders both opaque and non-opaque materials in the virtual environment.

9. The method of claim 1, wherein determining the transparency value further comprises applying the Beer-Lambert law to the first material based on one or more of: an absorptivity of the first material, the distance between the first plane and the first 3D graphical object, and the adjustable density value for the first material.

10. The method of claim 1, wherein the virtual environment comprises an extended reality (XR) virtual environment.

11. The method of claim 10, wherein the virtual environment further comprises a system-level layer, upon which one or more application-level layers may be rendered.

12. The method of claim 1, wherein determining the transparency value is further based, at least in part, on a current value of a time-of-day variable for the virtual environment.

13. A method of graphical rendering, comprising:
obtaining a first three-dimensional (3D) graphical object, wherein the first 3D graphical object is associated with at least a first material, wherein the first material comprises a 3D volume with an adjustable position within a virtual environment, and wherein the first material is associated with an adjustable density value and a 3D noise texture;
determining a transparency value based, at least in part, on values within the 3D noise texture between a first viewpoint and the first 3D graphical object; and
rendering, from the first viewpoint and using a first shader, at least a portion of the first 3D graphical object in the virtual environment by applying the determined transparency value to the first material.

14. The method of claim 13, wherein the first 3D graphical object is further associated with a second material, and wherein the rendering of at least a portion of the first 3D graphical object in the virtual environment further comprises:
blending between the first material and the second material according to the determined transparency value.

15. The method of claim 14, wherein the rendering of at least a portion of the first 3D graphical object in the virtual environment further comprises, for one or more rendered pixels of the first 3D graphical object:
(a) computing a first plurality of points along a first ray emanating from the first viewpoint and terminating at a respective rendered pixel of the first 3D object, wherein at least a part of the first ray passes through the 3D volume, and wherein the first ray intersects with the first 3D object at an intersection point;
(b) computing an integration value based on noise values corresponding to locations of each of the first plurality of points within the 3D noise texture and the adjustable density value;
(c) determining based, at least in part, on the computed integration value, a first transparency value to apply to the first material at the intersection point; and
(d) rendering a portion of the first 3D graphical object at the intersection point based, at least in part, on the determined first transparency value, the first material, and a portion of the second material corresponding to the first 3D graphical object at the intersection point.

16. The method of claim 13, wherein the 3D noise texture comprises a tiling 3D volume.

17. The method of claim 13, wherein the first material comprises at least one of: fog, mist, water, cloud, dust, or particles.

18. The method of claim 15, wherein computing the integration value further comprises:
computing a summation of the adjustable density value multiplied by noise values corresponding to locations of each of the first plurality of points within the 3D noise texture.

19. A device comprising: a memory; and one or more processors configured to perform the method of claim 1.

20. A non-transitory computer-readable medium that stores instructions that, when executed, cause the performance of the method of claim 13.
